(19) United States
(12) Patent Application Publication
(10) Pub. No.: US 2026/0346988 A1
(43) Pub. Date: Nov. 5, 2026

(54) Asymmetrical Four-Point Shoulder Belt

(71) Applicant: Elevate Aircraft Seating LLC, Bothell, WA (US)

(72) Inventors: Uwe Reichel, Kottweiler-Schwanden (DE); Viktor Fenske, Marnheim (DE); Matthias Nitzko, Kirchheimbolanden (DE); Holger Emrich, Erdesbach (DE)

(21) Appl. No.: 19/198,390

(22) Filed: May 5, 2025

(51) Int. Cl. B64D 11/06

(52) U.S. Cl. CPC B64D 11/062

(57) ABSTRACT

An asymmetrical four-point shoulder belt harness for an oblique seat for an aircraft. The shoulder belt harness includes a first shoulder belt, a second shoulder belt, a lap belt, and a buckle. The first shoulder belt extends from a first side of a backrest of the oblique seat to the buckle while the second shoulder belt extends from a second side of the backrest to the buckle. The lap belt is connected to the first side of the oblique seat and extends to the buckle. An attachment point positioned on the second side of the oblique seat releasably engages the buckle. During a deceleration of the aircraft, the first shoulder belt applies a first restraint pressure and the second shoulder belt applies a second restraint pressure, where the first restraint pressure and the second restraint pressure flank a centerline of the passenger seated in the oblique seat.

### BACKGROUND INFORMATION

### 1. Field

The present disclosure relates generally to a passenger suite of an aircraft. More specifically, the present disclosure relates to a seatbelt for oblique arranged business class seats of an aircraft.

### 2. Background

Oblique aircraft seating arrangements are utilized to maximize seating numbers and provide privacy separation in the limited space of a business class passenger suite of an aircraft. Oblique aircraft seats are side-facing seats oriented at an angle relative to the aircraft's longitudinal centerline. Oblique aircraft seats are often installed at angles of 20-50 degrees to the aircraft's centerline. Typically, oblique aircraft seats utilize a 3-point restraint system similar to what is found in today's automobile. A shoulder belt of the 3-point restraint system is anchored at the passenger's clavicle and crosses the passenger's chest/neck to a buckle positioned on the hip of the passenger on an opposite side of the passenger from where the shoulder belt originated. A lap belt originates on one hip of the passenger and is joined to the shoulder belt at the buckle across the lap of the passenger. In the event of a sudden deceleration, the typical 3-point restraint system places unwanted pressure on the chest and neck area of the passenger.

Therefore, it would be desirable to have a method and apparatus that takes into account at least some of the issues discussed above, as well as other possible issues.

### SUMMARY

An illustrative embodiment of the present disclosure provides a shoulder belt harness for an oblique seat for an aircraft. The shoulder belt harness includes a first shoulder belt, a second shoulder belt, a lap belt, and a buckle. The first shoulder belt extends from a first side of a backrest of the oblique seat to the buckle while the second shoulder belt extends from a second side of the backrest to the buckle. The lap belt is connected to the first side of the oblique seat and extends to the buckle. An attachment point positioned on the second side of the oblique seat releasably engages the buckle.

Another illustrative embodiment of the present disclosure provides a passenger suite for an aircraft. The passenger suite includes an oblique seat, a first shoulder belt, a second shoulder belt, and a lap belt. The oblique seat has a first side, a second side, a seat portion, and a backrest portion. The first shoulder belt extends from the first side of the backrest portion. The second shoulder belt extends from the second side of the backrest portion. The lap belt extends from the first side of the seat portion. The first shoulder belt, the second shoulder belt, and the lap belt are all connected to an attachment point on the second side of the seat portion.

A further illustrative embodiment of the present disclosure provides a method for restraining a passenger in an oblique aircraft seat of an aircraft. A first shoulder belt is extended from a first side of a backrest of the oblique aircraft seat to a buckle. A second shoulder belt is extended from a second side of the backrest of the oblique aircraft seat to the buckle. A lap belt is extended from the first side of the oblique aircraft seat to the buckle. The buckle is engaged with an attachment point on the second side of the oblique aircraft seat, wherein the second side of the oblique aircraft seat is forward of the first side of the oblique aircraft seat along a direction of travel axis of the aircraft.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a platform in accordance with an illustrative embodiment;

FIG. 2 is an illustration of a top view of an oblique seat for an aircraft in accordance with an illustrative embodiment;

FIG. 3 is an illustration of a perspective view from behind an oblique seat for an aircraft in accordance with an illustrative embodiment;

FIG. 4 is an illustration of a flowchart of a process for restraining a passenger in an oblique aircraft seat of an aircraft in accordance with an illustrative embodiment;

FIG. 5 is an illustration of a block diagram of an aircraft manufacturing and service method in accordance with an illustrative embodiment; and

FIG. 6 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that passenger suite layouts for commercial aircraft, particularly business class seats and up, often incorporate oblique seats for efficient use of space and to provide privacy between passengers seated in the passenger suite.

The illustrative embodiments also recognize and take into account that typical three-point restraint system contact and cross a passenger's chest and neck area. In the event of a sudden deceleration, the typical 3-point restraint system places unwanted pressure on the chest and neck area of the passenger.

Thus, the illustrative embodiments provide an asymmetrical four-point shoulder belt for an oblique aircraft seat that includes shoulder belts that do not contact a passenger's neck. The illustrative embodiments provide an asymmetrical four-point shoulder belt for an oblique aircraft seat that in the event of a sudden deceleration, the space between the shoulder belts and the neck of the passenger remains within the permitted limits while still securing the passenger in place in the oblique aircraft seat.

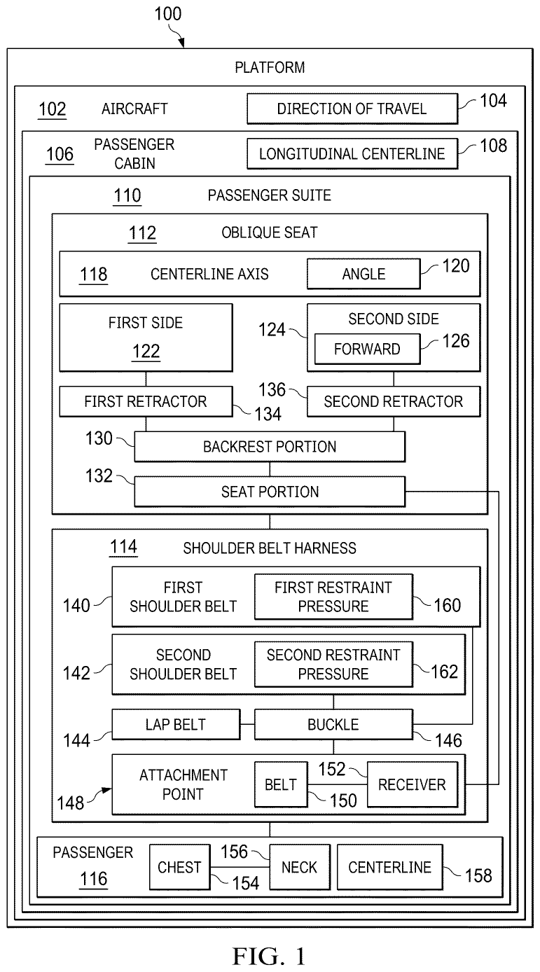

With reference now to the figures and, in particular, with reference to FIG. 1, an illustration of a block diagram of a platform is depicted in accordance with an illustrative example. Platform 100 has aircraft 102 in this illustrative example.

The illustration of aircraft 102 in FIG. 1 is not meant to imply physical or architectural limitations to the manner in which an illustrative example may be implemented. For example, although aircraft 102 may be a commercial aircraft, aircraft 102 may be a military aircraft, a rotorcraft, a helicopter, an unmanned aerial vehicle, or any other suitable aircraft that includes an armrest assembly.

Although the illustrative examples are described with respect to an aircraft, the illustrative example may be applied to other types of platforms. The platform may be, for example, a mobile platform, a stationary platform, a land-based structure, an aquatic-based structure, or a space-based structure. More specifically, the platform may be an aircraft, a surface ship, a tank, a personnel carrier, a train, a spacecraft, a space station, a satellite, a submarine, an automobile, a power plant, a bridge, a dam, a house, a manufacturing facility, a building, a tool, a mechanical structure, or some other suitable platform or structure where a shoulder belt harness is desirable.

In this illustrative example, platform 100 takes the form of aircraft 102. In this illustrative example, when platform 100 takes the form of aircraft 102, aircraft 102 includes direction of travel 104. Direction of travel 104, or the direction of travel axis, is the, generally linear, direction the aircraft flies when operating. As will be discussed below, the orientation of the oblique aircraft seat and the features of the shoulder belt harness are all dependent on the particular direction of direction of travel 104.

Aircraft 102 includes passenger cabin 106. Passenger cabin 106 typically runs longitudinal along the length of aircraft 102 and leads to at least one passenger suite 110. As a result, passenger cabin 106 has longitudinal centerline 108. Generally, longitudinal center line 108 is parallel with direction of travel 104.

Passenger suite 110 includes at least one oblique seat 112. Oblique seat 112 is fitted with shoulder belt harness 114. Shoulder belt 114 safely secures passenger 116 in oblique seat 112. Passenger suite 110 may include more than one oblique seat 112 each with a corresponding shoulder belt harness 114. Oblique aircraft seating arrangements are utilized to maximize seating capacity and provide privacy separation in the limited space of passenger suite 110. An oblique seat is considered a side-facing seat having a centerline axis oriented at an angle relative to the aircraft's longitudinal centerline. Oblique seat 112 has centerline axis 118. Centerline axis 118 is oriented at angle 120 from direction of travel 104 or longitudinal centerline 108. Angle 120 may range from 20-50 degrees relative to direction of travel 104 or longitudinal centerline 108. The optimal angle will be determined by space constraints and seating capacity requirement of a particular aircraft.

Because the orientation and features of oblique seat 112 and shoulder belt harness 114 are important to the operation of oblique seat 112 and shoulder belt harness 114, it will be necessary to describe features relative to positional sides of the seat and direction of travel 104. As a result, oblique seat 112 has first side 122 and second side 124. Because oblique seat 112 is oriented at angle 120 relative to direction of travel 104, second side 124 is forward 126 of first side 122 along direction of direction of travel 104. This orientation is important when describing the location of other features of oblique seat 112 and shoulder belt harness 114 to be discussed below.

Oblique seat 112 includes backrest portion 130 connected to seat portion 132. Backrest portion 130 supports the back of a passenger seated in oblique seat 112 while seat portion 132 supports the main weight of the passenger seated in oblique seat 112. First side 122 and second side 124 are opposite lateral sides of oblique seat 112. As a result, first side 122 and second side 124 also apply to backrest portion 130 and seat portion 132.

First retractor 134 is mounted to backrest portion 130 on first side 122. Second retractor 136 is mounted to backrest portion 130 on second side 124. First retractor 134 and second retractor 136 operate as typical, pre-tensioning seat belt retractors do.

Shoulder belt harness 114 includes first shoulder belt 140, second shoulder belt 142, lap belt 144, buckle 146 and attachment point 148.

One end of first shoulder belt 140 is connected to first retractor 134. The opposite end of first shoulder blet 140 is connected to buckle 146. One end of second shoulder belt 142 is connected to second retractor 136. The opposite end of second shoulder belt 142 is connected to buckle 146. One end of lap belt 144 is connected to first side 122 of seat portion 132. The opposite end of lap belt 144 is connected to buckle 146. Attachment point 148 is positioned on second side 124 of seat portion 132 of oblique seat 112. Attachment point 148 may be connected to seat portion 132 or may be connected to other structural elements of oblique seat 112. It is important that attachment point is positioned on second side 124 of oblique seat 112. Attachment point 148 includes belt 150 and receiver 152 connected to belt 150. Receiver 152 operates to releasably engage buckle 146. Since first shoulder belt 140, second shoulder belt 142 and lap belt 144 are all connected to buckle 146, attachment point 148 is a releasable attachment point for first shoulder belt 140, second shoulder belt 142 and lap belt 144 to second side 124 of oblique seat 112.

Passenger 116 is an example of a passenger capable of sitting in oblique seat 112 during operation of aircraft 102. Passenger 116 includes chest 154 connected to neck 156. Passenger 116 has centerline 158. Centerline 158 can be described as the vertical midline that passes through chest 154 and neck 156.

In use, because of the specific connection locations of first shoulder belt 140, second shoulder belt 142 and lap belt 144 relative to the specific sides of oblique seat 112, during a deceleration event, first restraint pressure 160 provided by first shoulder belt 140 on passenger 116 and second restraint pressure 162 provided by second shoulder belt 142 on passenger 116 flank centerline 158 of passenger 116. During a deceleration event, the momentum of passenger 116 wants to keep moving passenger 116 in direction of travel 104. Because of the specific connection locations of first shoulder belt 140, second shoulder belt 142 and lap belt 144 relative to the specific sides of oblique seat 112 which are determined by the direction of travel, the locations of where first restraint pressure 160 and second restraint pressure 162 are applied do not put undue stress on neck 156 of passenger 116.

As used herein, a first component “connected to” or “coupled to” or “associated with” a second component means that the first component can be connected directly or indirectly to the second component. The connection is a physical association. In other words, additional components may be present between the first component and the second component. The first component is considered to be indirectly connected to the second component when one or more additional components are present between the two components. When the first component is directly connected to the second component, no additional components are present between the two components.

For example, a first component can be considered to be physically connected to a second component by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

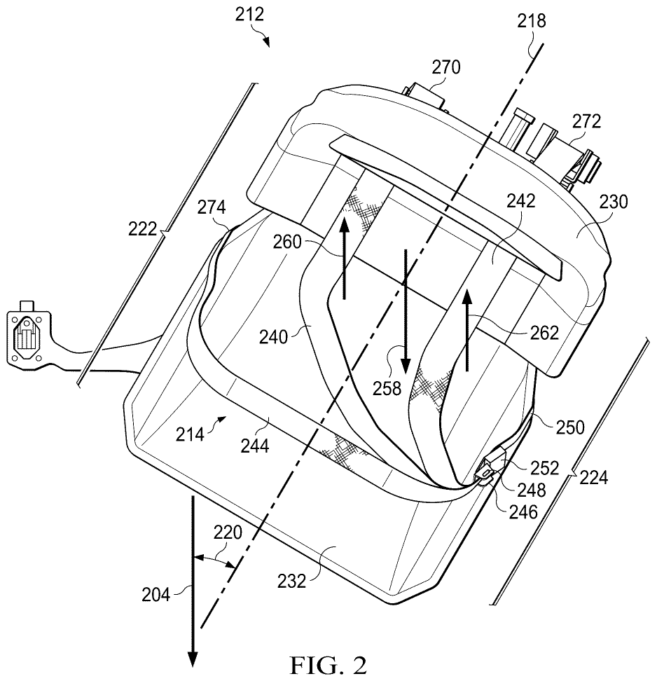

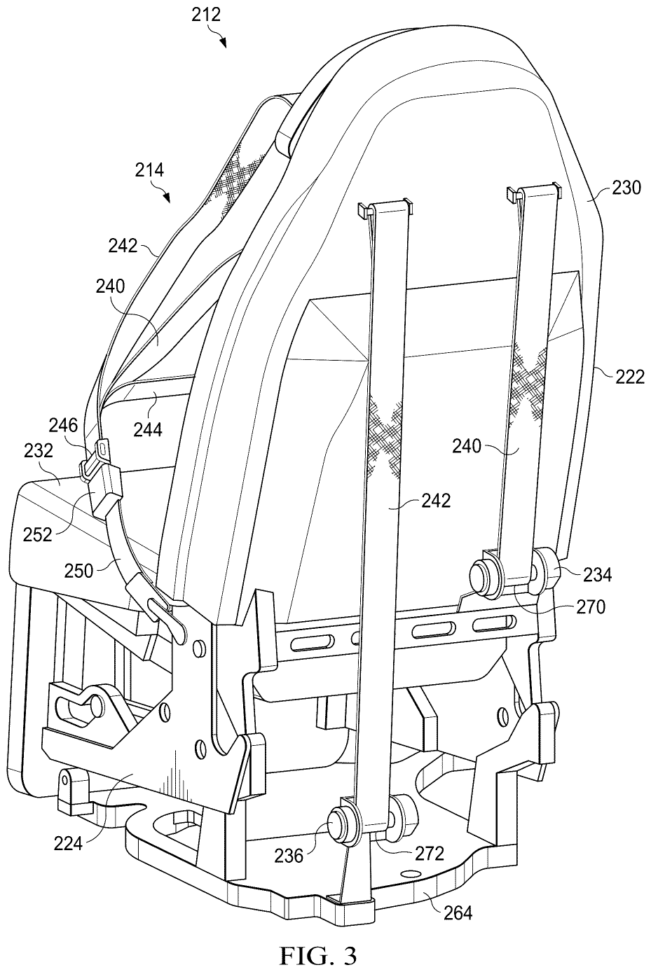

With reference next to FIGS. 2 and 3, illustrations of an oblique seat for an aircraft are depicted in accordance with an illustrative example. In this illustrative example and the illustrative examples that follow, the same reference numeral may be used in more than one figure. This reuse of a reference numeral in different figures represents the same element in the different figures. The components illustrated in FIG. 2 are examples of physical implementations of oblique seat 112 and shoulder belt harness 114 shown in block form in FIG. 1.

Oblique seat 212 has centerline axis 218. Centerline axis 218 is oriented at angle 220 from direction of travel 204. Angle 220 may range from 20-50 degrees relative to direction of travel 204. The optimal angle will be determined by space constraints and seating capacity requirement of a particular aircraft.

Oblique seat 212 has first side 222 and second side 224. Because oblique seat 212 is oriented at angle 220 relative to direction of travel 204, second side 224 is forward of first side 222 along the direction of direction of travel 204. This orientation is important when describing the location of other features of oblique seat 212 and shoulder belt harness 214.

Oblique seat 212 includes backrest portion 230 connected to seat portion 232. Backrest portion 230 supports the back of a passenger seated in oblique seat 212 while seat portion 232 supports the underside or the main weight of the passenger seated in oblique seat 212. First side 222 and second side 224 are opposite lateral sides of oblique seat 212. First side 222 and second side 224 orientations also apply to backrest portion 230 and seat portion 232.

First retractor 234 is mounted to backrest portion 230 on first side 222. Second retractor 236 is mounted to baseplate 264 of backrest portion 230 on second side 224. First retractor 234 and second retractor 236 operate as typical, pre-tensioning seat belt retractors do.

Shoulder belt harness 214 includes first shoulder belt 240, second shoulder belt 242, lap belt 244, buckle 246 and attachment point 248.

End 270 of first shoulder belt 240 is connected to first retractor 234. The opposite end of first shoulder belt 240 is connected to buckle 246. End 272 of second shoulder belt 242 is connected to second retractor 236. The opposite end of second shoulder belt 242 is connected to buckle 246. End 274 of lap belt 244 is connected to first side 222 of seat portion 232. The opposite end of lap belt 244 is connected to buckle 246. Attachment point 248 is positioned on second side 224 of seat portion 232 of oblique seat 212. Attachment point 248 may be connected to seat portion 232 or may be connected to other structural elements of oblique seat 212 as long as attachment point is positioned on second side 224. It is important that attachment point is positioned on second side 224 of oblique seat 212. Attachment point 248 includes belt 250 and receiver 252 connected to belt 250. Receiver 252 operates to releasably engage buckle 246. Since first shoulder belt 240, second shoulder belt 242, and lap belt 244 are all connected to buckle 246, attachment point 248 is a releasable attachment point for first shoulder belt 240, second shoulder belt 242 and lap belt 244 to second side 224 of oblique seat 212.

As illustrated, because of the direction of direction of travel 204, first side 222 may be considered the right-hand side of a passenger seated in oblique seat 212 and second side 224 may be considered the left-hand side. It is important, based on the illustrated direction of travel 204, that attachment point 248 is on second side 224, or in this illustrated example, the left-hand side of oblique seat 212. Should oblique seat be positioned on an opposite side of a passenger cabin and be angled in an opposite direction as to that depicted in FIG. 2, the features of shoulder belt harness 214 and the locations of connections relative to the sides of the oblique seat would need to be the mirror opposite as to what is described above.

In the case of deceleration of the aircraft, momentum of a passenger seated inside the aircraft will tend to move the mass of the passenger in a direction parallel with direction of travel 204. Arrow 258 represents movement of the centerline of the passenger, the centerline including the neck of the passenger. The momentum causes first restraint pressure (indicated by arrow 260) and second restraint pressure (indicated by arrow 262) to be applied to a passenger seated in oblique seat 212. What is important is that first restraint pressure 260 provided by first shoulder belt 240 and second restraint pressure 262 provided by second shoulder belt 242 flank centerline 258 of the passenger. Because of the specific connection locations of first shoulder belt 240, second shoulder belt 242 and lap belt 244 relative to the direction of travel 204, the locations of where first restraint pressure 260 and second restraint pressure 262 are applied do not put undue stress on the neck of a passenger seated in oblique seat 212.

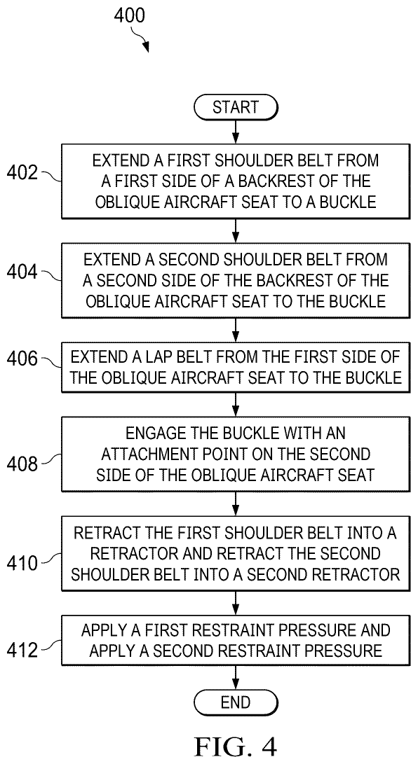

With reference next to FIG. 4, an illustration of a flowchart of a process 600 for restraining a passenger in an oblique aircraft seat of an aircraft is depicted in accordance with an illustrative example. The method depicted in FIG. 4 may be used in conjunction with the oblique seat and shoulder belt harness depicted in FIGS. 1-3.

The process begins by extending a first shoulder belt from a first side of a backrest of the oblique aircraft seat to a buckle (operation 402). The first shoulder belt is unfurled from a first retractor positioned on the first side of a backrest portion of the oblique aircraft seat. The process continues by extending a second shoulder belt from a second side of the backrest of the oblique aircraft seat to the buckle (operation 404). The second shoulder belt is unfurled from a second retractor positioned on the second side of a backrest portion of the oblique aircraft seat. At operation 406, a lap belt is extended from the first side of the oblique aircraft seat to the buckle. At operation 408, the buckle is releasably engaged with an attachment point located on the second side of the oblique aircraft seat. The second side of the oblique aircraft seat is forward of the first side of the oblique aircraft seat along a direction of travel axis of the aircraft. At operation 610, the process continues by retracting the first shoulder belt into the first retractor to position the first shoulder belt against the passenger and retracting the second shoulder belt into the second retractor to position the second shoulder belt against the passenger. At operation 612, during a reduction of velocity of the aircraft, a first restraint pressure provided by the first shoulder belt and a second restraint pressure provided by the second shoulder belt is applied to the passenger. The first restraint pressure and the second restraint pressure flank a centerline of the passenger seated in the oblique aircraft seat. The process ends thereafter.

In some alternative implementations of an illustrative example, the function or functions noted in the blocks may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

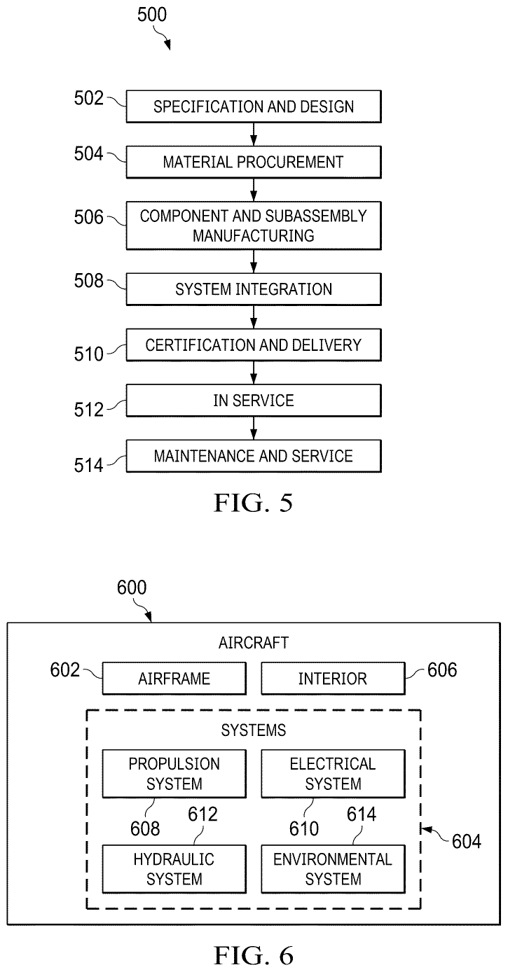

The illustrative embodiments of the disclosure may be further described in the context of aircraft manufacturing and service method 500 as shown in FIG. 5 and aircraft 600 as shown in FIG. 6. Turning first to FIG. 5, an illustration of a block diagram of an aircraft manufacturing and service method is depicted in accordance with an illustrative embodiment. During pre-production, aircraft manufacturing and service method 500 may include specification and design 502 of aircraft 600 in FIG. 6 and material procurement 504.

During production, component and subassembly manufacturing 506 and system integration 508 of aircraft 600 in FIG. 6 takes place. Thereafter, aircraft 600 in FIG. 6 may go through certification and delivery 510 in order to be placed in service 512. While in service 512 by a customer, aircraft 600 in FIG. 6 is scheduled for routine maintenance and service 514, which may include modification, reconfiguration, refurbishment, and other maintenance, service, or inspection.

The apparatus of this disclosure may be installed on an aircraft during component and subassembly manufacturing 506. In addition, the apparatus of this disclosure may be retrofitted onto aircraft 600 in FIG. 6 during routine maintenance and service 514 as part of a modification, reconfiguration, or refurbishment of aircraft 600 in FIG. 6.

Each of the processes of aircraft manufacturing and service method 500 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 6, an illustration of a block diagram of an aircraft is depicted in which an illustrative embodiment may be implemented. In this example, aircraft 600 is produced by aircraft manufacturing and service method 500 in FIG. 5 and may include airframe 602 with plurality of systems 604 and interior 606. Examples of systems 604 include one or more of propulsion system 608, electrical system 610, hydraulic system 612, and environmental system 614. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 500 in FIG. 5. In one illustrative example, components or subassemblies produced in component and subassembly manufacturing 506 in FIG. 5 may be fabricated or manufactured in a manner similar to components or subassemblies produced while aircraft 600 is in service 512 in FIG. 5. As yet another example, one or more apparatus embodiments, method embodiments, or a combination thereof may be utilized during production stages, such as component and subassembly manufacturing 506 and system integration 508 in FIG. 5. One or more apparatus embodiments, method embodiments, or a combination thereof may be utilized while aircraft 600 is in service 512, during maintenance and service 514, inclusive of inspection, in FIG. 5, or both. The use of a number of the different illustrative embodiments may substantially expedite the assembly of aircraft 600, reduce the cost of aircraft 600, or both expedite the assembly of aircraft 600 and reduce the cost of aircraft 600.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A shoulder belt harness for an oblique seat for an aircraft, comprising:
a first shoulder belt connected to and extending from a first side of a backrest of the oblique seat to a buckle;
a second shoulder belt connected to and extending from a second side of the backrest of the oblique seat to the buckle;
a lap belt connected to and extending from the first side of the oblique seat to the buckle; and
an attachment point positioned on the second side of the oblique seat, the attachment point for releasable engagement with the buckle.

2. The shoulder belt harness of claim 1, wherein the second side of the oblique seat is forward of the first side of the oblique seat along a direction of travel axis of the aircraft.

3. The shoulder belt harness of claim 1, wherein a centerline axis of the oblique seat is angled in a range of 30-50 degrees from a direction of travel axis of the aircraft.

4. The shoulder belt harness of claim 1, wherein the first shoulder belt is connected to a first retractor on the first side of the backrest of the oblique seat.

5. The shoulder belt harness of claim 4, wherein the second shoulder belt is connected to a second retractor on the second side of the backrest connected to a baseplate of the oblique seat.

6. The shoulder belt harness of claim 1, wherein the attachment point comprises a belt connected to the second side of the oblique seat and a receiver connected to the belt, the receiver configured to releasably engage the buckle.

7. The shoulder belt harness of claim 1, wherein a neck of a passenger seated in the oblique seat does not engage the first shoulder belt or the second shoulder belt in the event of a reduction of velocity of the aircraft in a direction of travel of the aircraft.

8. The shoulder belt harness of claim 1, wherein during a reduction of velocity of the aircraft in a direction of travel of the aircraft, a first restraint pressure provided by the first shoulder belt and a second restraint pressure provided by the second shoulder belt flank a centerline of a passenger seated in the oblique seat.

9. A passenger suite for an aircraft, comprising:
an oblique seat comprising a first side, a second side, a seat portion, and a backrest portion;
a first shoulder belt extending from the first side of the backrest portion;
a second shoulder belt extending from the second side of the backrest portion;
a lap belt extending from the first side of the seat portion; and
the first shoulder belt, the second shoulder belt, and the lap belt all connected to an attachment point on the second side of the seat portion.

10. The passenger suite of claim 9, further comprising:
a buckle connected to each of the first shoulder belt, the second shoulder belt, and the lap belt, wherein the buckle is releasably engaged with the attachment point.

11. The passenger suite of claim 9, wherein the second side of the oblique seat is forward of the first side of the oblique seat along a direction of travel axis of the aircraft.

12. The passenger suite of claim 9, wherein a centerline axis of the oblique seat is angled in a range of 30-50 degrees from a direction of travel axis of the aircraft.

13. The passenger suite of claim 9, wherein the oblique seat comprises:
a first retractor mounted on the first side of the backrest portion and connected to the first shoulder belt.

14. The passenger suite of claim 13, wherein the oblique seat comprises:
a second retractor mounted to a baseplate of the oblique seat, the second retractor connected to the second shoulder belt.

15. The passenger suite of claim 9, wherein the attachment point comprises:
a buckle connected to the first shoulder belt, the second shoulder belt, and the lap belt; and
a belt connected to the second side of the seat portion and a receiver connected to the belt, the receiver configured to releasably engage the buckle.

16. The passenger suite of claim 9, wherein during a reduction of velocity of the aircraft in a direction of travel of the aircraft, a first restraint pressure provided by the first shoulder belt and a second restraint pressure provided by the second shoulder belt flank a centerline of a passenger seated in the oblique seat.

17. A method for restraining a passenger in an oblique aircraft seat of an aircraft, comprising:
extending a first shoulder belt from a first side of a backrest of the oblique aircraft seat to a buckle;
extending a second shoulder belt from a second side of the backrest of the oblique aircraft seat to the buckle;
extending a lap belt from the first side of the oblique aircraft seat to the buckle; and
engaging the buckle with an attachment point on the second side of the oblique aircraft seat, wherein the second side of the oblique aircraft seat is forward of the first side of the oblique aircraft seat along a direction of travel axis of the aircraft.

18. The method of claim 17, wherein the extending the first shoulder belt comprises extending the first shoulder belt from a first retractor connected to the first side of the backrest of the oblique aircraft seat and the extending the second shoulder belt comprises extending the second shoulder belt from a second retractor connected to a baseplate connected to the second side of the backrest of the oblique aircraft seat.

19. The method of claim 18, further comprising:
retracting the first shoulder belt into the first retractor to position the first shoulder belt against the passenger; and
retracting the second shoulder belt into the second retractor to position the second shoulder belt against the passenger.

20. The method of claim 17, further comprising:
during a reduction of velocity of the aircraft in a direction of travel of the aircraft, applying a first restraint pressure provided by the first shoulder belt and applying a second restraint pressure provided by the second shoulder belt to the passenger, where the first restraint pressure and the second restraint pressure flank a centerline of the passenger seated in the oblique aircraft seat.
